(19) United States
(12) Patent Application Publication
(10) Pub. No.: US 2020/0030177 A1
(43) Pub. Date: Jan. 30, 2020

(54) CABLE OPERATED MOTION AUGMENTATION SYSTEM AND METHOD

(71) Applicant: Abilitech Medical, Inc., Minneapolis, MN (US)

(72) Inventors: John Zentgraf, Minneapolis, MN (US); James Rohl, Minneapolis, MN (US); Joe Schachtner, Minneapolis, MN (US); Eli Krumholz, Minneapolis, MN (US); Rob Wudlick, Minneapolis, MN (US); Travis Yoch, Minneapolis, MN (US); Chris Narveson, Minneapolis, MN (US); Rob Roberts, Minneapolis, MN (US); Rod Landers, Minneapolis, MN (US); Angie Conley, Minneapolis, MN (US); Brett Neubauer, Minneapolis, MN (US)

(21) Appl. No.: 16/491,509

(22) PCT Filed: Mar. 8, 2018
(86) PCT No.: PCT/US2018/021522

§ 371 Date: Sep. 5, 2019

Related U.S. Application Data
(60) Provisional application No. 62/468,566, filed on Mar. 8, 2017.

(51) Int. Cl. A61H 1/02

(52) U.S. Cl. CPC A61H 1/0274; A61H 1/0277; A61H 1/0281; A61H 1/0285; A61H 2230/04; A61H 2201/5064; A61H 2201/165; A61H 2201/1676; A61H 2201/5007

(57) ABSTRACT

A motion augmentation system configured to utilize a plurality of cables to augment the user's native strength to aid in the movement of an appendage of a user through a desired range of motion by applying forces between a first body part and an appendage of the user, such that a natural anatomy of the user is at least partially used as a structure to affect movement. The motion augmentation system including a plurality of cables operably coupling a body chassis to at least one sleeve assembly, each of the plurality of cables traversing through a corresponding one of a plurality of embedded lumens within the sleeve assembly and controlled by one or more corresponding cable actuators operably coupled to the body chassis, the corresponding cable actuators configured to selectively apply a force via the plurality of cables between the body chassis in the at least one sleeve assembly.

### RELATED APPLICATIONS

This present application is a National Phase entry of PCT Application No. PCT/US2018/021522 filed Mar. 8, 2018 which claims priority to U.S. Provisional Application No. 62/468,566 filed Mar. 8, 2017, the contents of each being incorporated herein by reference in their entireties

491

### TECHNICAL FIELD

The present disclosure relates generally to systems and methods for upper extremity lift and assist of patient suffering from a loss of motor skills. More particularly, the present disclosure relates to a cable operated upper torso augmentation system and method of use configured to augment upper body movement, providing motor skills in patients suffering from neuromuscular disorders, spinal injuries, and/or impairment of limbs.

### BACKGROUND

Individuals with neuromuscular abnormalities, such as neuromuscular disorders, spinal injuries, or impairment of limbs as a result of a stroke, often experience muscular atrophy and/or impaired motor function, which can lead to a loss of full functionality in their limbs and upper body. Such a loss in functionality can make the performance of routine tasks difficult, thereby adversely affecting the individual's quality of life.

In the United States alone, 1.4 million people suffer from neuromuscular disorders. It is estimated that approximately 45,000 of these people are children, who are affected by one or more pediatric neuromuscular disorders. Pediatric neuromuscular disorders include Spinal Muscular Atrophy (SMA), cerebral palsy, Arthrogryposis Multiplex Congenital (AMC), Becker Muscular Dystrophy, and Duchenne Muscular Dystrophy (DMD). Adult neuromuscular diseases include Multiple Sclerosis (MS), Amyotrophic Lateral Sclerosis (ALS) and Facioscapulohumeral Muscular Dystrophy (FSHD). Many of these muscular disorders are progressive, such that there is a slow degeneration of the spinal cord and/or brainstem motor neurons resulting in generalized weakness, atrophy of skeletal muscles, and/or hypotonia.

In the United States, approximately 285,000 people suffer from spinal cord injuries, with 17,000 new cases added each year. Approximately 54% of spinal cord injuries are cervical injuries, resulting in upper extremity neuromuscular motor impairment. Spinal cord injuries can cause morbid chronic conditions, such as lack of voluntary movement, problematic spasticity, and other physical impairments which can result in a lower quality of life and lack of independence.

In the United States, it is estimated that there are over 650,000 new surviving stroke victims each year. Approximately 70-80% of stroke victims have upper limb impairment and/or hemiparesis. Numerous other individuals fall victim to Silent Cerebral Infarctions (SCI), or “silent strokes,” which can also lead to progressive limb impairment. Complications from limb impairment and hemiparesis may involve spasticity, or the involuntary contraction of muscles when an individual tries to move their limb. If left untreated, the spasticity can result in the muscles freezing in abnormal and painful positions. Also, following a stroke, there is an increased possibility of developing hypertonicity, or the increased tightness of muscle tone.

People afflicted with neuromuscular abnormalities often exhibit diminished fine and gross motor skills. In cases where a person is capable of only asymmetric control of the particular joint, the person may be able to control the muscle group responsible for flexion about the joint, but his or her control over the muscle group responsible for extension may be impaired. Similarly, the opposite may be true, in that the user may have control in the extension direction, but not in the flexion direction. In either case, if the person cannot exert his or her triceps or release a hyperactive bicep, the person may be unlikely to perform the task they desire. Even in cases where a person retains symmetric control over a joint, the person may be left with reduced control over muscle groups on opposite sides of the joint. As a result, the person may be incapable of achieving the full range of motion that the joint would normally permit and/or be incapable of controlling the joint so that the associated limb segments exert the amount of force required to perform the desired task.

In many cases, a reduction in strength or impairment of motor function, as a result of neuromuscular abnormalities, can be slowed, stopped, or even reversed through active treatment and therapy. At least for stroke victims, data suggests that the sooner that the therapy is started after the impaired motor function is first noticed, and the greater the amount of therapy that is performed by the patient, the more likely the patient is to have a better recovery. Unfortunately, the therapy often utilizes expensive equipment and is limited to in-clinic settings, thereby significantly restricting the amount of therapy that can be performed by the patient.

In other cases, such as with progressive neuromuscular disorders, the goal of the treatment may be to slow the decline in functionality, so as to maintain the individual's quality of life for as long as possible. Common treatment methods include physical therapy combined with medications to provide symptomatic relief. Recent advances in orthoses for patients with degenerative muscle disorders have been very limited. Most orthoses have been designed with active power sources for in clinic treatment; however, some passively powered devices have also been developed. One example of a passively powered device for the treatment of neuromuscular disorders is disclosed in U.S. Pat. No. 6,821,259 (assigned to the Nemours Foundation), the contents of which are incorporated by reference herein.

Regarding spinal cord injuries, while there are no known treatments that can reverse morbidities, repetitive high-intensity exercise and the use of orthoses have been used to improve the strength and overall neuromuscular health of patients. In particular, a number of arm support devices have been used by patients to strengthen upper extremities and improve independence for accomplishing activities of daily living. Nevertheless, continuous use of these devices throughout daily life is limited by their high cost, bulk, weight, lack of comfort, and limited functionality.

There remains a need for a low-profile motion augmentation system and method for people afflicted with neuromuscular abnormalities that can address the limitations and issues associated with the current devices and methods.

### SUMMARY OF THE DISCLOSURE

Embodiments of the present disclosure provide for low-profile, modular ambulatory devices and methods for user's with neuromuscular abnormalities. Embodiments of the present disclosure enable users to experience an improved range of motion, thereby improving independence, enabling the completion of activities of daily living (ADL), and/or to reinforce therapeutic regimens (e.g., Constraint Induced Movement Therapy (CIMT) or repetitive motion). Mechanical adjustments combined with firmware controlled modes of operation enable the user to balance both torque and load requirements to complete ADLs. Embodiments of the present disclosure can be passively powered, actively powered, or a hybrid of passive and active powered. Embodiments of the present disclosure can include a hybrid passive-direct and active-indirect drive assembly. Embodiments of the present disclosure can further amplify known therapy methods by enabling automatic tracking of movements and grading of tasks through an integrated mobile computing device during extended use throughout the period of use.

One embodiment of the present disclosure provides a motion augmentation system configured to be worn around a first body structure of a user and to utilize a plurality of cables to augment the native strength of the user to aid in the movement of an appendage of the user through a desired range of motion by applying a force between the first body structure and the appendage. The motion augmentation system can include a body chassis, at least one sleeve assembly, and a plurality of cables. The body chassis can be configured to be worn around the first body structure. The at least one sleeve assembly can be configured to be worn around the appendage, and can include a plurality of embedded lumens traversing through at least a partial length of the at least one sleeve assembly. The plurality of cables can operably coupled the body chassis to the at least one sleeve assembly. Each of the plurality of cables can traverse through a corresponding one of the plurality of embedded lumens of the sleeve assembly and can be controlled by one or more corresponding cable actuators operably coupled to the body chassis. The corresponding body actuators can be configured to selectively apply a force via the plurality of cables between the body chassis and the at least one sleeve assembly, such that the body chassis and a natural anatomy of the user are at least partially used as a structure against which the sleeve assembly pivots in response to the applied force.

In one embodiment, the body chassis and the at least one sleeve assembly can be substantially free-floating relative to one another. In one embodiment, the at least one sleeve assembly includes an upper appendage sleeve assembly and a lower appendage sleeve assembly. In one embodiment the upper appendage sleeve assembly and the lower appendage sleeve assembly are operably coupled to one another via a resilient coupling. In one embodiment, the resilient coupling substantially inhibits the lower appendage sleeve assembly from translating closer to the upper appendage sleeve assembly along a longitudinal axis of the resilient coupling when the force is applied between the body chassis and the at least one sleeve assembly. In one embodiment, the motion augmentation system further includes a processor configured to direct the one or more cable actuators to increase augmentation of the native strength of the user in maneuvering the appendage in a predefined direction based on cues from the user. In one embodiment, the motion augmentation system further includes a processor configured to record a path of motion of the appendage and direct the one or more cable actuators in maneuvering the appendage along the recorded path of motion. In one embodiment, the motion augmentation system further includes one or more sensing devices configured to monitor one or more clinical parameters of interest during use. In one embodiment, the motion augmentation system further includes a processor configured to utilize the one or more clinical parameters of interest to determine an increased fatigue of the user and to dynamically adjust one or more cable actuators to compensate for the increased fatigue. In one embodiment, the motion augmentation system further includes one or more passive elements configured to selectively apply at least a portion of the force between the body chassis and the at least one sleeve assembly. In one embodiment, the cable actuators are configured to apply the force between the body chassis and the at least one sleeve assembly by changing a force output of the one or more passive elements.

Another embodiment of the present disclosure provides a low-profile, conformable multilayer motion augmentation system configured to be worn around a first body structure of the user and to augment a native strength of the user by aiding movement of an upper appendage and a lower appendage of the user. The multilayer motion augmentation system can include a first layer and a second layer. The first layer can include a body chassis, a plurality of cables, and a plurality of cable actuators. The body chassis can be configured to be worn around the first body structure. The plurality of cables can be at least partially constrained relative to the upper appendage and the lower appendage by a plurality of cable restraints, wherein at least one of the plurality of cables is unconstrained relative to a joint between the upper appendage and the lower appendage. Each of the plurality of cable actuators can be operably coupled to the body chassis and can be configured to impart a force on a respective one of the plurality of cables. The second layer can include an elastic sleeve portion configured to sheath at least a portion of the plurality of cables and cable restraints of the first layer, wherein the at least one of the plurality of cables that is unconstrained relative to the joint between the upper appendage in the lower appendage, in combination with the elastic sleeve portion, defines a leading edge of a cable wing.

In one embodiment, first layer can further include an upper appendage sleeve assembly and a lower appendage sleeve assembly. In one embodiment, the upper appendage sleeve assembly and lower appendage sleeve assembly can be operably coupled to one another via a resilient coupling. In one embodiment, the resilient coupling can inhibit the lower appendage sleeve assembly from translating closer to the upper appendage sleeve assembly along a longitudinal axis of the resilient coupling when the force is applied to the plurality of cables.

Another embodiment of the present disclosure provides an upper torso augmentation system configured to utilize a plurality of cables to augment a user's state of strength to aid in the movement of the user's arms through a desired range of motion by applying forces to portions of the user's chest and arms, while relying substantially on the user's anatomy as a pivotable structure. The upper torso augmentation system can include a body chassis, at least one compliant sleeve assembly, and a plurality of cables. The body chassis can be configured to be worn around the torso of the user to augment core stability. The at least one compliant sleeve assembly can be configured to be worn around an arm of the user, and can include a plurality of embedded lumens traversing through at least a partial length of the sleeve assembly. The plurality of cables can operably couple the body chassis to the at least one sleeve assembly. Each of the plurality of cables can traverse through a corresponding one of the plurality of embedded lumens of the sleeve assembly and can be controlled by one or more corresponding cable actuators operably coupled to a second anchor location on the opposite side of an anatomic joint from the compliant sleeve. The corresponding cable actuators can be configured to selectively apply a force via the plurality of cables between the second anchor location and the at least one sleeve assembly.

Another embodiment of the present disclosure provides a low-profile, conformable multilayer upper torso augmentation system configured to augment the user's native strength by aiding movement of the user's upper limb. The multilayer upper torso augmentation system can include a first layer and a second layer. The first layer can include a body chassis, a plurality of cables, and a plurality of cable actuators. The body chassis can be configured to be worn around the torso of the user. The plurality of cables can be at least partially constrained relative to the user's upper limb by a plurality of cable restraints, wherein at least one of the plurality of cables is unconstrained relative to the elbow of a user. Each of the plurality of cable actuators can be operably coupled to the body chassis and can be configured to impart a force on a respective one of the plurality of cables. The second layer can include an elastic sleeve portion configured to sheath at least a portion of the plurality of cables and cable restraints of the first layer. At least one of the plurality of cables that is unconstrained relative to the elbow of a user in combination with the elastic sleeve portion can define a leading edge of a cable wing extending between a portion of the body chassis and the user's wrist.

Another embodiment of the present disclosure provides an intent activatable upper torso augmentation system configured to increase augmentation of a user's native strength in maneuvering the user's arm in a predefined direction based on cues from the user. The intent activatable upper torso augmentation system can include a body chassis, at least one arm assembly, a cable assembly, and a processor. The body chassis can be configured to be worn around a torso of the user. The at least one arm assembly can be configured to be worn around an arm of the user. The cable assembly can operably couple the body chassis to the at least one arm assembly and can be configured to augment the user's native strength in maneuvering the user's arm within a desired range of motion. The processor can be configured to receive information from the user and provide variable augmentation instructions to the cable assembly. The information received by the processor can include a position of the user's body, such that movement of the user's body in a given direction is interpreted by the processor as an intent by the user to move their arm in a corresponding direction. The variable augmentation instructions provided by the processor can direct the cable assembly to increase augmentation of the at least one arm assembly in the corresponding direction.

Another embodiment of the present disclosure provides an upper torso augmentation system configured to record a path of motion of a user's arm and selectively augment the user's native strength in repeated motion of the user's arm along the recorded path of motion. The upper torso augmentation system can include a body chassis, at least one arm assembly, a cable assembly, and a processor. The body chassis can be configured to be worn around a torso of the user. The at least one arm assembly can be configured to be worn around an arm of the user. The cable assembly can operably couple the body chassis to the at least one arm assembly and can be configured to augment the user's native strength in maneuvering the user's arm within a desired range of motion. The processor can be configured to receive and record positional information based on movement of the user's arm and selectively provide variable augmentation instructions to the cable assembly. The positional information can include a desired repeatable path of motion of the user's arm. The variable augmentation instructions provided by the processor can direct the cable assembly to increase augmentation of the at least one arm assembly to guide the user's arm along the desired repeatable path of motion.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting an upper torso augmentation system, in accordance with a first embodiment of the disclosure.

FIG. 2A is a front perspective view depicting an upper torso augmentation system, in accordance with a second embodiment of the disclosure.

FIGS. 2B-E are perspective views depicting manipulation of the upper torso augmentation system of FIG. 2A through a range of motions, in accordance with the disclosure.

FIG. 2F is a rear perspective view depicting the upper torso augmentation system of FIG. 2A.

FIG. 3A is a perspective view depicting an alternate variant of the upper torso augmentation system, in accordance with the second embodiment of the disclosure.

FIGS. 3B-C are perspective views depicting manipulation of the upper torso augmentation system of FIG. 3A through a range of motions, in accordance with the disclosure.

FIGS. 4A-B are cross-sectional views depicting embedded conformable lumens of a sleeve assembly, in accordance with an embodiment of the disclosure.

FIG. 5 is a perspective view depicting an upper torso augmentation system with cables having flexible transition sleeves in accordance with an embodiment of the disclosure.

FIG. 6A is a front view depicting a user utilizing an upper torso augmentation system configured to prioritize augmentation of limb movement within a predefined three-dimensional range of motion, in accordance with an embodiment of the disclosure.

FIG. 6B is a profile view depicting a user utilizing the upper torso augmentation system of FIG. 6A.

FIG. 6C is a top view depicting a user utilizing the upper torso augmentation system of FIG. 6A.

FIG. 6D is a perspective view depicting a user utilizing the upper torso of rotation system of FIG. 6A.

FIG. 7A-E are perspective views depicting an inner layer of an upper torso augmentation system, in accordance with a third embodiment of the disclosure.

FIG. 8A is a perspective view depicting multiple layers of the upper torso augmentation system of FIG. 7A-E.

FIG. 8B is a close-up, perspective view depicting interaction multiple layers of the upper torso augmentation system of FIG. 8A.

FIGS. 8C-F are alternative views depicting manipulation of the upper torso augmentation system of FIG. 8A through a range of motions, in accordance with the disclosure.

FIG. 9 is a schematic view depicting an upper torso augmentation system including a plurality of sensing devices, in accordance with an embodiment of the disclosure.

FIG. 10 is a depiction of a flow of information from data sensed by one or more sensing devices, in accordance with an embodiment of the disclosure.

While embodiments of the disclosure are amenable to various modifications and alternative forms, specifics thereof are shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure as defined by the appended claims.

### DETAILED DESCRIPTION

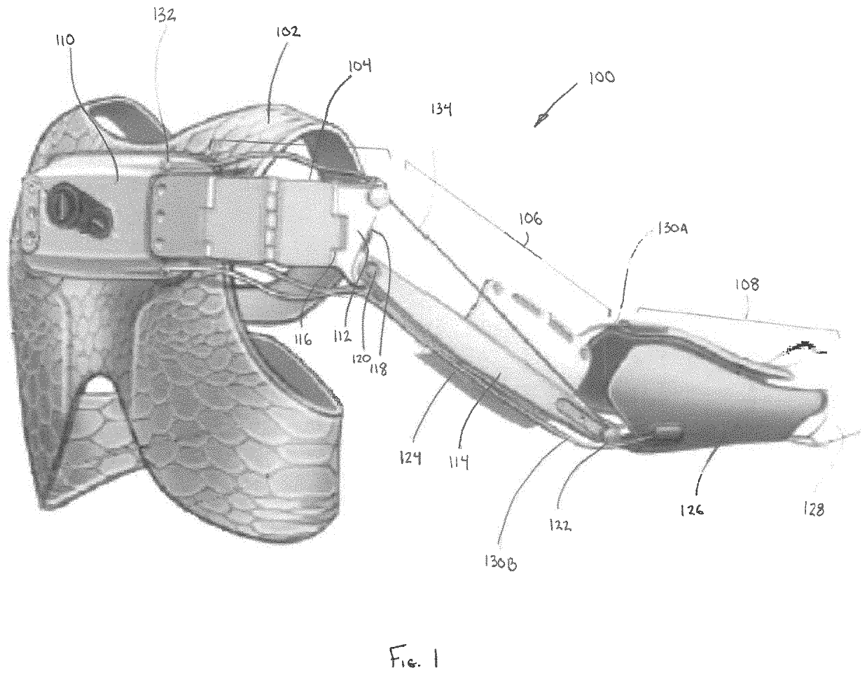

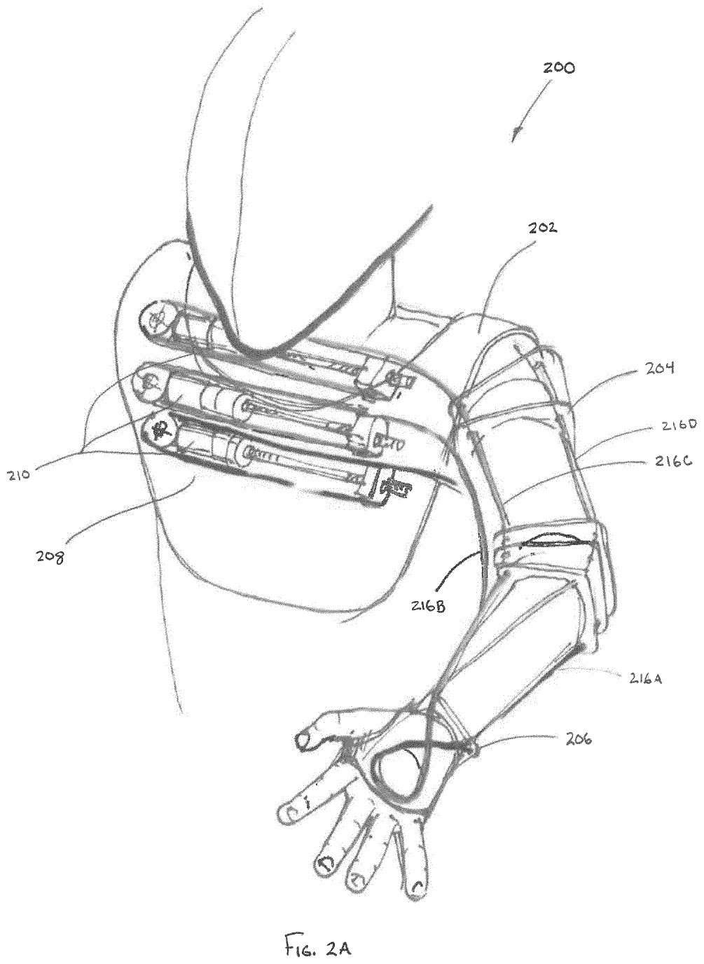

Referring to FIG. 1 an upper torso augmentation system 100 is depicted in accordance with an embodiment of the disclosure. The upper torso augmentation system 100 can be configured to assist a user in daily tasks and/or therapeutic treatments by using a cable assembly to decrease the force required of a user to counteract gravity during maneuvering of their arm. As used herein, the term “user” and “patient” can be used interchangeably to refer to can refer to an individual with neuromuscular abnormalities, such as neuromuscular disorders, spinal injuries and limb impairment as a result of a stroke. In one embodiment, the upper torso augmentation system 100 can include a body chassis 102, shoulder assembly 104, upper arm assembly 106, and lower arm assembly 108.

The upper torso augmentation system 100 can fit closely to the user, in a low-profile manner. The upper torso augmentation system 100 can be constructed of lightweight, high-strength fabrics, plastics and metals to reduce bulk and minimize discomfort, thereby promoting wearability of the augmentation system 100 for long periods of time, while enabling a broad array of Range of Motion (ROM) activities. In one embodiment, the range of motion can include wrist extension, wrist flexion, lower arm pronation, lower arm supination, elbow flexion, upper arm elevation, upper arm rotation, and/or shoulder rotation. In one embodiment, the body chassis 102 can comprise a wearable garment, such as a vest, to be worn around the body (e.g., shoulders and torso) of the user. For example, in one embodiment, the body chassis 102 can be constructed as a series of layers, with various levels of rigidity and support configured to suit the user's needs. The body chassis 102 can be constructed of one or more breathable, stretchable, lightweight, and/or low friction fabrics, such as neoprene, 3-D printed nylon and other flexible polymers.

In some embodiments, the body chassis 102 can be provided with positionable support panels with varying rigidities, so that the rigidity and/or support of portions of the body chassis 102 can be zoned as to accommodate movements of various degrees and extents. For example, in one embodiment, the body chassis 102 can include a plurality of rigid members working in concert with a plurality of breathable, stretchable, lightweight, and/or low friction fabrics. In such an embodiment, the body chassis 102 can include a pair of lateral support members and a pair of shoulder support members operably coupleable to one or more hubs via adjustable fasteners, such that the length and/or angle of the lateral support and shoulder support members can be adjusted. For improved comfort, the hubs can include respective torso cushioned pads configured to conform to the user's torso. Accordingly, disclosed embodiments enable the body chassis 102 to be modified in order to have the rigidity and/or flexibility as desired by the user.

In some embodiments, the body chassis 102 can be modular in nature, for example, in one embodiment, the body chassis 102, shoulder assembly 104, upper arm assembly 106, and/or lower arm assembly 108 can be easily interchanged for a different sized and/or shaped body chassis 102, shoulder assembly 104, upper arm assembly 106, and lower arm assembly 108, in order to accommodate users of different sizes, ages and other physical characteristics.

In one embodiment, the body chassis 102 includes a support panel 110. Support panel 110 can serve as a coupling point between the body chassis 102 and the shoulder assembly 104. In some embodiments, the support panel 110 is positioned on the exterior surface of the body chassis 102. In other embodiments, the support panel 110 can be positioned between one or more layers of the body chassis 102.

The shoulder assembly 104 can include two or more shoulder hinge plates pivotably coupled to one another. As depicted in FIG. 1, the shoulder assembly 104 includes three shoulder hinge plates; however, other shoulder assembly 104 configurations are also contemplated.

The upper arm assembly 106 can be constructed as a two bar linkage assembly. The upper arm assembly 106 can include proximal linkage 112 and lateral linkage 114. The proximal linkage 112 can have a proximal end 116 and a distal end 122. The proximal end 116 of the proximal linkage 112 can be pivotably coupled to the shoulder assembly 104.

The lateral linkage 114 can include a proximal end 120 and a distal end 122. The distal end 118 of proximal linkage 112 can be pivotably coupled to the proximal end 120 of the lateral linkage 114. In one embodiment, an upper arm cuff 124 can be operably coupled to lateral linkage 114. The upper arm cuff 124 can be configured to support and/or couple to a portion of a user's upper arm.

A cable 134 such as a Bowden cable, can be operably connected between the distal end 122 of the lateral linkage 114 and the distal end 118 of the proximal linkage 112. A portion of the cable 134 can extend to a cable actuator 132. In one embodiment, the cable actuator 132 can be positioned proximal to the support panel 110. Actuation of the cable 134 can cause lateral linkage 114 to pivot relative to proximal linkage 112, thereby augmenting the movement of the user's arm in an up-and-down motion about the shoulder.

The lower arm assembly 108 can include a lower arm cuff 126 pivotably coupled to the distal end 122 of lateral linkage 114. In other embodiments, the lower arm cuff 126 can be at least partially free-floating relative to upper arm assembly 106, so as to rely on the user's elbow as the pivot mechanism (i.e., the upper torso augmentation system can be anatomically dependent, in that it at least partially uses the user's anatomic structure as a frame). The lower arm cuff 126 can be configured to support and/or couple to a portion of a user's lower arm. Lower arm assembly 108 can further include a hand wrap 128 configured to support and/or couple to a portion of a user's hand.

One or more cables 130A/B can be operably coupled to lower arm cuff 126. Portions of cables 130A/B can extend to the cable actuator 132. Actuation of cables 130A/B can serve to augment movement of the lower arm assembly 108 to correspond to pivoting and/or rotational movement of the user's lower arm about the user's elbow. In one embodiment, the pair of cables 130A/B can work in cooperation together to affect movement. For example, one cable 130A can exert a pulling force, while the other cable 130B exerts a pushing force. Thus, in one embodiment, bilateral pairs of cables 130A/B can cooperate to effectuate movement.

Actuation of cables 134, 130A/B via cable actuator 132 can be performed by an elastomer band or a spring in conjunction with one or more cams designed to create a torque profile to match the required gravitational assistance. Accordingly, in one embodiment, the upper torso augmentation system 100 can be considered to be passively powered, in that the spring merely serves as a mechanism to store potential energy. In one embodiment, the springs and/or cams can be interchanged or adjusted to match specific user needs. In one embodiment, a mechanical advantage can be applied to further increase the torque and/or forces applied to the various cables 134, 130 through the use of a block and tackle system.

In another embodiment, the actuation of cables 134, 130A/B can be actively powered by one or more powered actuators. For example, actuators can be electric, pneumatic or hydraulic actuators, knitted muscles, or nanotube construction actuators. The actuators can be linear servos or rotary motors with gear drives. In another embodiment, the upper torso augmentation system 100 can be configured to assist a user through the use of a hybrid power source that includes both passive and actively powered actuation. For example, in one embodiment, the upper torso augmentation system 100 can include one or more elastic members configured to store potential energy to aid the user in raising and lowering their arm to overcome the effects of gravity, as well as an actively powered cable assembly configured to further augment the user's native strength and maneuvering the user's arm. Like earlier disclosed embodiments, the springs, cams and/or actuators can be adjusted to meet the anti-gravitational needs of the user.

The required torque necessary to assist a user's native strength can be computed, for example, by multiplying the mass of the user's arm by the lateral distance between the user's shoulder (i.e. the axis of rotation) in the center of mass of the user's arm, wherein the lateral distance is substantially perpendicular to the Earth's gravitational force. Accordingly, the torque of the arm can follow a sinusoidal relationship with the angle of the arm, such that little to no torque is required when the user's arm is substantially vertical, and a maximum amount torque is required when the user's arm is substantially perpendicular to the Earth's gravitational force. The actuation of cables 134, 130 can match these torque requirements for the purpose of counteracting the effects of gravity.

Depending on the needs of the user, the degree to which the upper torso augmentation system 100 counteracts the effects of gravity can be adjusted. In one embodiment, the upper torso augmentation system 100 can be configured to provide a small lifting force, for example, a fraction of the weight of the user's arm. In other embodiments, the upper torso augmentation system 100 can provide a lifting force substantially equal to the weight of the user's arm. In yet other embodiments, the upper torso augmentation system 100 can provide a lifting force substantially equal to the weight of the user's arm plus an object for which the user wishes to lift.

In one embodiment, user skin contacting portions of the upper torso augmentation system 100, such as the body chassis 102, the upper arm cuff 124, the lower arm cuff 126, and the hand wrap 128 can closely conform to the contours of the user. In one embodiment, these portions can be 3-D printed from a three-dimensional scan of the user's anatomy. In another embodiment, these portions can be vacuum thermoformed over a mold of the user. In some embodiments, these portions can be conformable to the user through a combination of pressure and/or heat.

In one embodiment, the upper torso augmentation system 100 is modular in nature, such that various components of the upper torso augmentation system 100 can be removed and/or replaced with different sizes and/or shapes of components to accommodate users of different sizes, ages, weights, and other physical characteristics. Depending upon the user's needs, portions of the upper torso augmentation system 100 can be removed. For example, certain users may only require the upper arm assembly 106 to meet their desired level of augmentation. Thus, the upper torso augmentation system 100 can be constructed using just the body chassis 102, shoulder assembly 104 and upper arm assembly 106. Accordingly, the modularity of the upper torso augmentation system 100 enables the device 100 to be fitted to users of varying sizes, and enables the device 100 to be modified to accommodate growth in child users.

In one embodiment, one or more of the pivotable couplings can be quick disconnect couplings, thereby enabling the various components of the orthotic device to be disassembled and/or separated without the use of tools. For example, in one embodiment, the shoulder assembly 104 can be uncoupled from the body chassis 102, and optionally coupled to another fixture, such as a chair, wheelchair or bed.

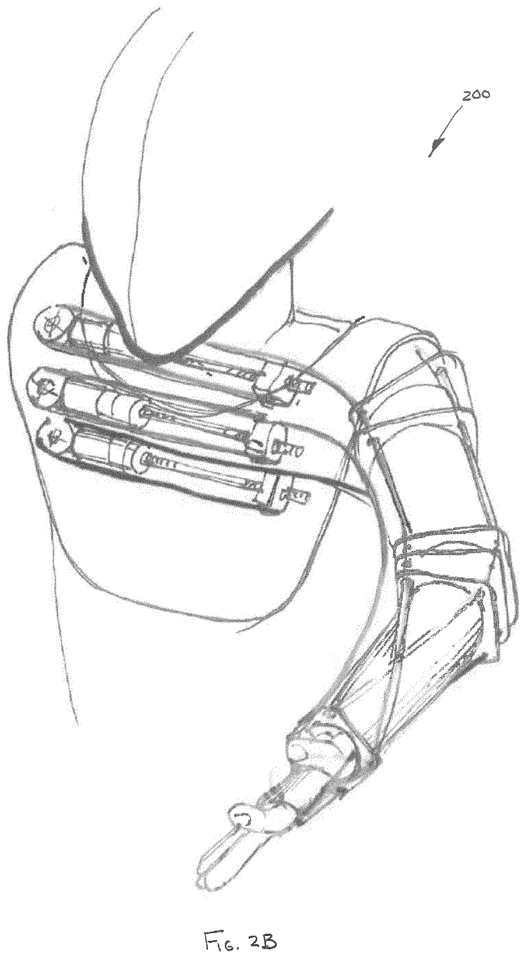

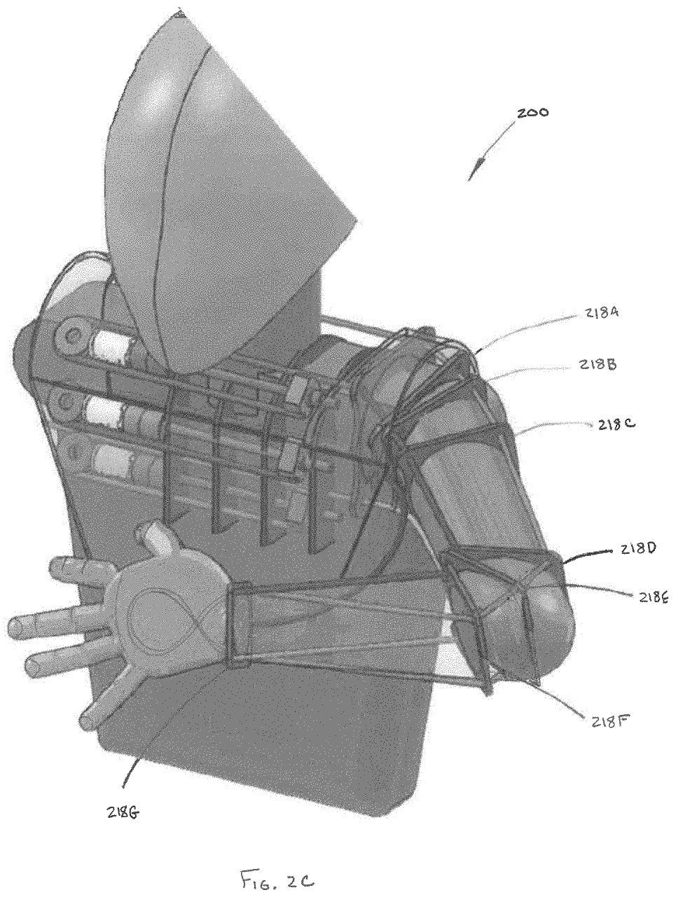

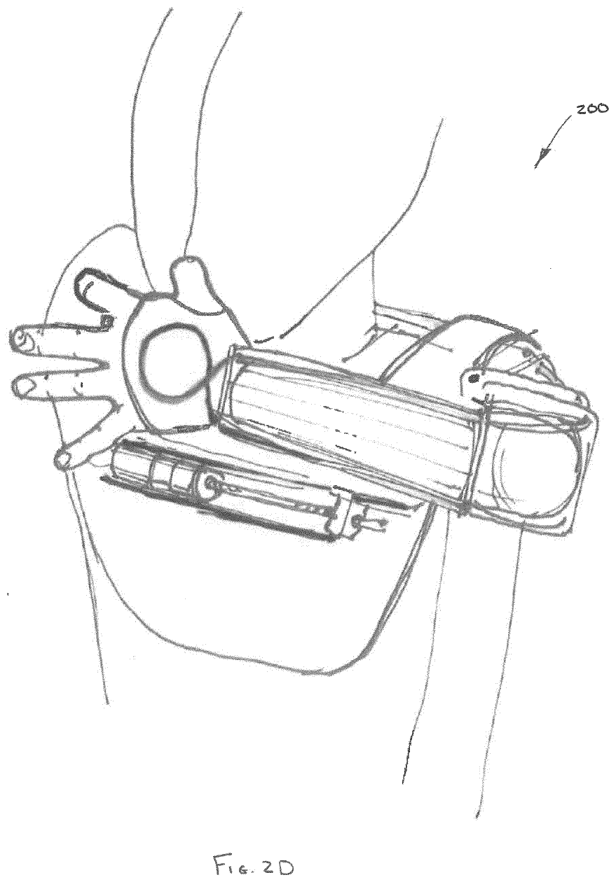

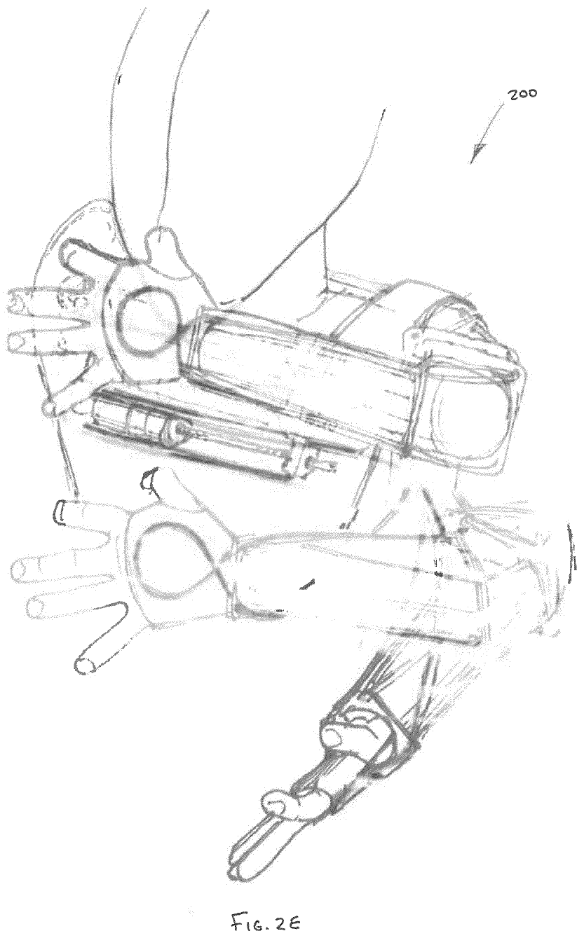

Referring to FIGS. 2A-F and 3A-C, other embodiments of an upper torso augmentation system 200 are depicted in accordance with the disclosure. The upper torso augmentation system 200 can utilize a plurality of cables to assist the user in daily tasks and/or therapeutic treatments to lower the force required to counteract gravity and maneuver of the user's arm. The upper torso augmentation system 200 can include a body chassis 202, an upper arm assembly 204, and a lower arm assembly 206 (collectively referred to as a “sleeve assembly”). The body chassis 202 can be of a similar construction to previously disclosed embodiments, and can include one or more support panels 208 and one or more cable actuators 210. In one embodiment, one of the cable actuators 210 can be positioned on the front of the body chassis 202, while one or more other cable actuators 210 can be positioned on the back of the body chassis 202.

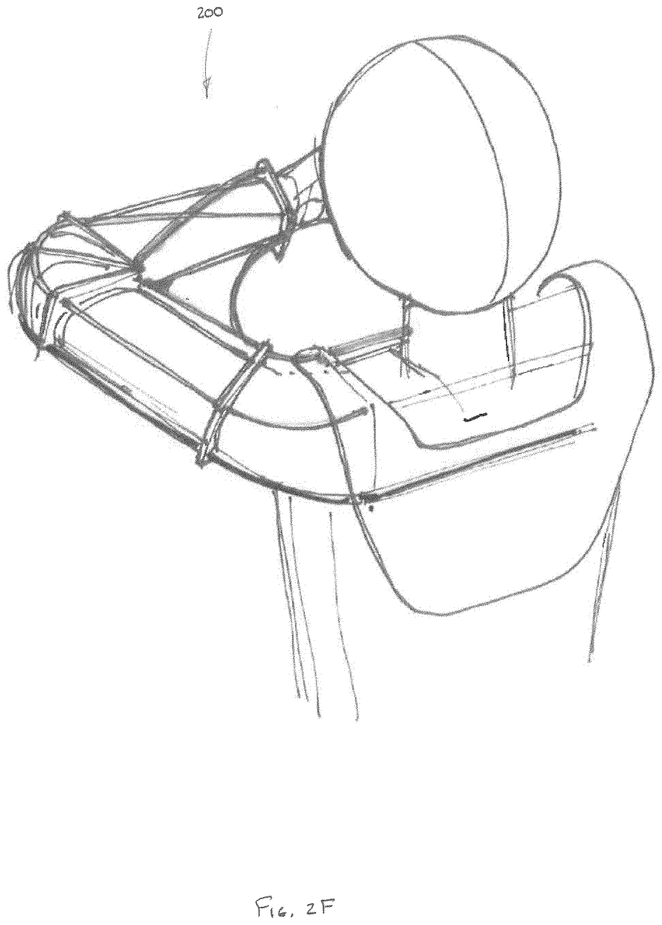

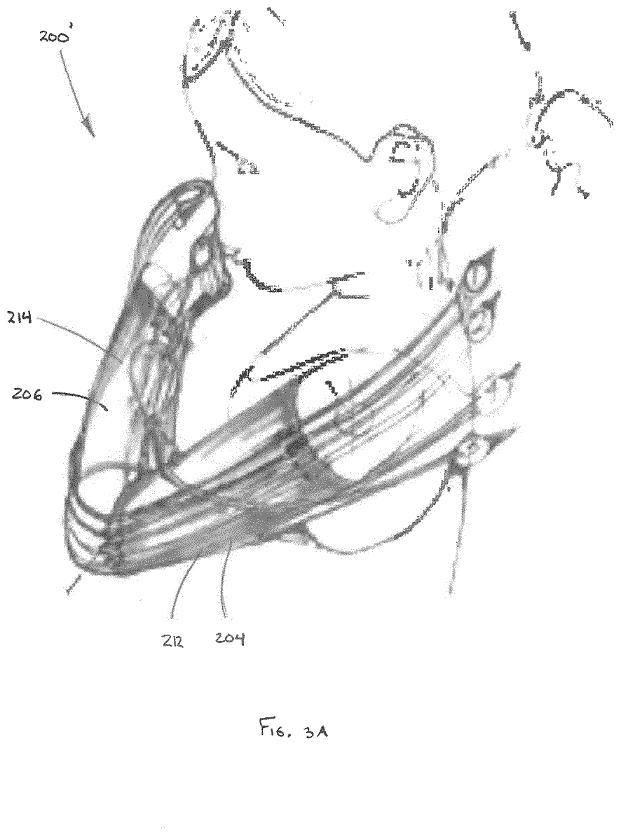

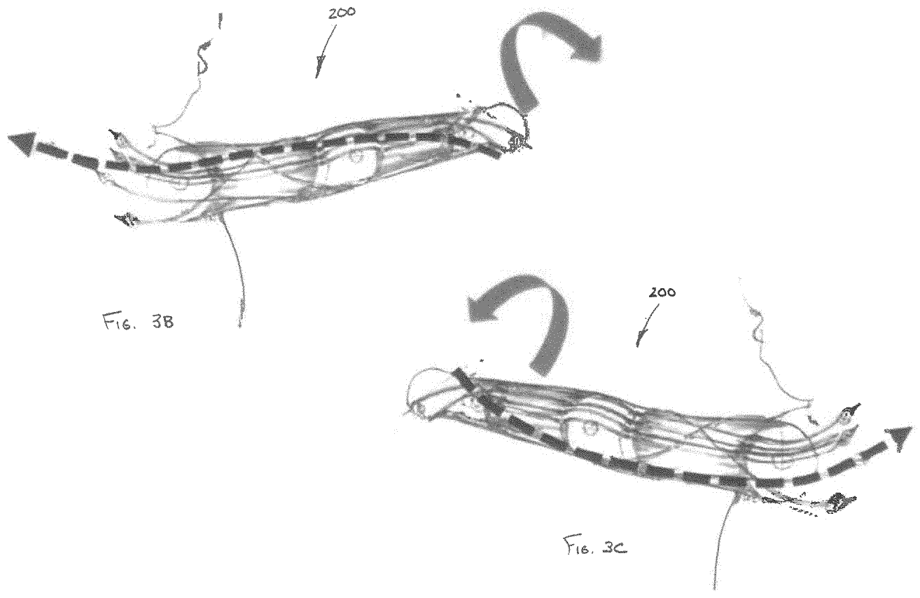

The upper arm assembly 204 and lower arm assembly 206 can include a respective upper arm cuff 212 and lower arm cuff 214 (as depicted in FIG. 3A). The upper arm cuff 212 and lower arm cuff 214 can be configured to support and/or couple to a portion of a user's arm. As in earlier embodiments, cuffs 212, 214 can be constructed of a semi-compliant, non-rigid material configured to provide support to the user while closely conforming to the contours of the user.

In some embodiments, the upper arm assembly 204, lower arm assembly 206 and body chassis 202 can be free-floating relative to one another. In other words, the arm assemblies 204, 206 and body chassis 202 can provide support to the user and apply forces to portions of the user's chest and arms, while being anatomically dependent upon the user's joints (i.e., shoulder and elbow) to pivot, rotate and/or shift relative to one another. Accordingly, orthotic device 200 provides a low profile antigravity assist mechanism, without the added weight and bulk of linkages and hinge points enabling motion of the various portions of the upper torso augmentation system 200 external to the user's anatomy.

A plurality of cables can be configured to traverse through portions of the upper arm assembly 204 and lower arm assembly 206, so as to terminate at the cable actuators 210. For example, in one embodiment, the upper torso augmentation system 200 can include four distinct cables 216A, 216B, 216C, and 216D, simulating muscle and tendons of the user. Inclusion a greater or lesser number of cables is also contemplated. In one embodiment, the cables are high tensile strength, small diameter metallic cables. In another embodiment, the cables are UHMWPE. Other cable constructions or monofilament constructs are also contemplated.

In one embodiment, the first and second cables 216A, 216B can traverse between the cable actuators 210 and a portion of the lower arm cuff 214 proximal to a top portion of the user's hand. For example, in one embodiment, the first and second cables 216A, 216B can be positioned on either side of the user's arm, in order to enable a rotational movement of the user's forearm. The third cable 216C can traverse between a cable actuator 210 and a portion of the lower arm cuff 214 proximal to the user's wrist. The fourth cable 216D can traverse between a cable actuator 210 positioned on the user's back and a portion of the lower arm cuff 214 proximal to the inside of the user's forearm.

In embodiments of the upper torso augmentation system 200, manipulation of cables 216A, 216B, 216C, and 216D can enable anti-gravitational and atrophied muscle assist for the purpose of articulating the user's arm according to a broad range of motion limited only by the physiology of the user. For example, FIGS. 2B-D depict manipulation of the cables 216 to affect movement of the user's arm both horizontally up and down and vertically away from and closer to the user's body. FIG. 2E depicts a dynamic view of the positions depicted in FIG. 2B-D. In addition to horizontal and vertical movement, manipulation of the cables 216 also enables supination and pronation. FIGS. 3B-C depict manipulation of the cables 216 to affect supination and pronation of the user's arm.

In some embodiments, the upper and/or lower arm assemblies 204, 206 can include a plurality of cable restraints 218A-G (as depicted in FIG. 2C), having embeddable conformable lumens configured to maintain the cables 216A-D and a certain position relative to the user's arm. The cable restraints 218A-G are depicted in FIG. 21 as a plurality of plates, however, in other embodiments, the embedded conformable lumens 218A-G can be integral to the upper arm cuff 212 and lower arm cuff 214.

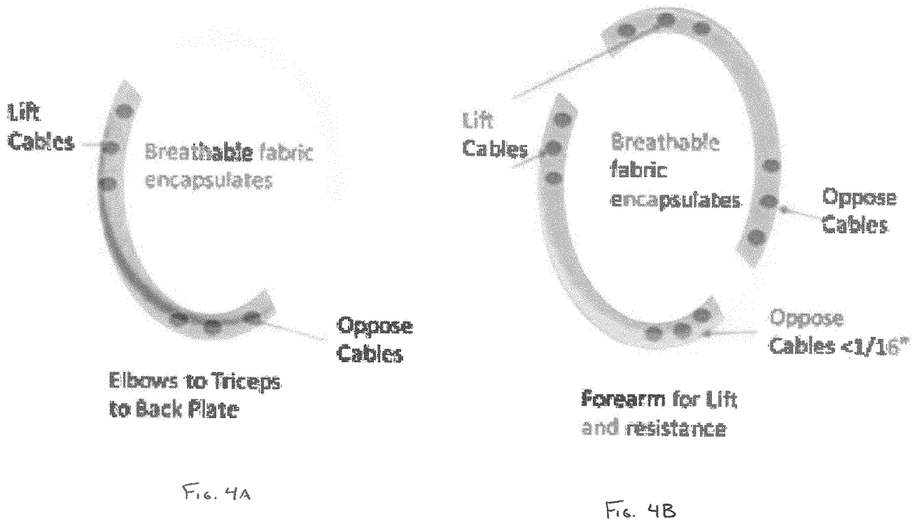

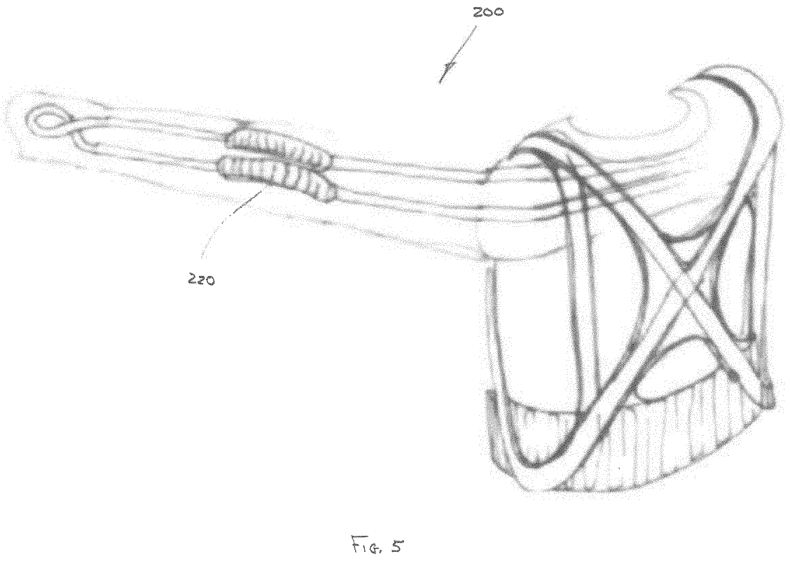

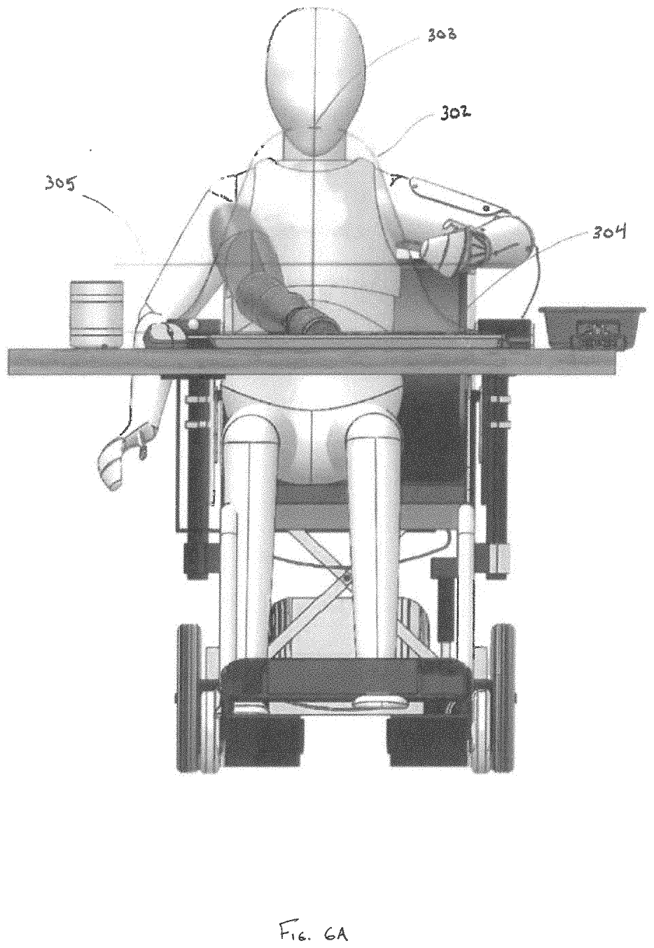

For example, as depicted in FIGS. 4A-B, the various cables 216 can be embedded within upper arm cuff 212 and lower arm cuff 214, for the purpose of shielding the cables, thereby improving the comfort and minimizing the profile of the upper torso augmentation system 200. As depicted in FIG. 5, in order to shield portions of cables, one or more flexible transition sleeves 220 can be positioned over a portion of cables 216A, 216B, 216C, and 216D, thereby inhibiting the cables from chafing the skin of the user and/or minimizing discomfort.

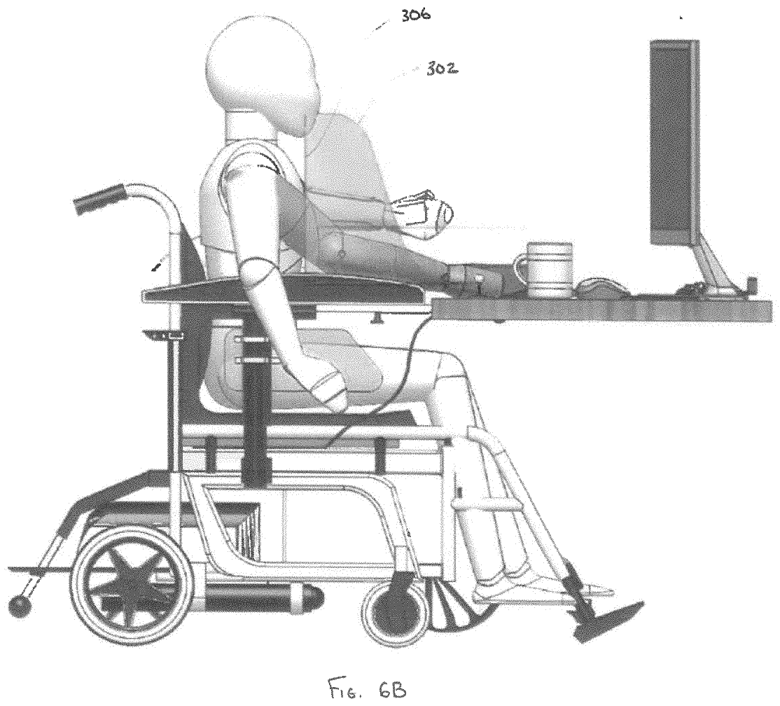

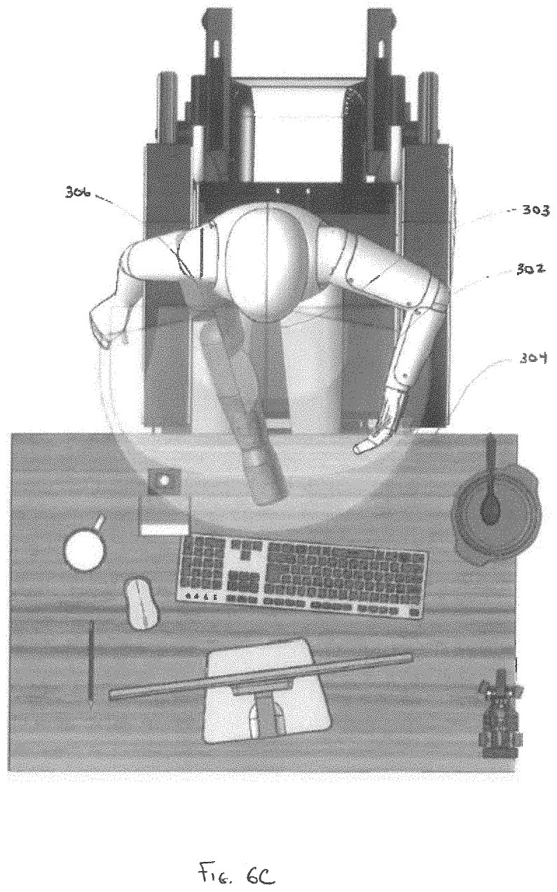

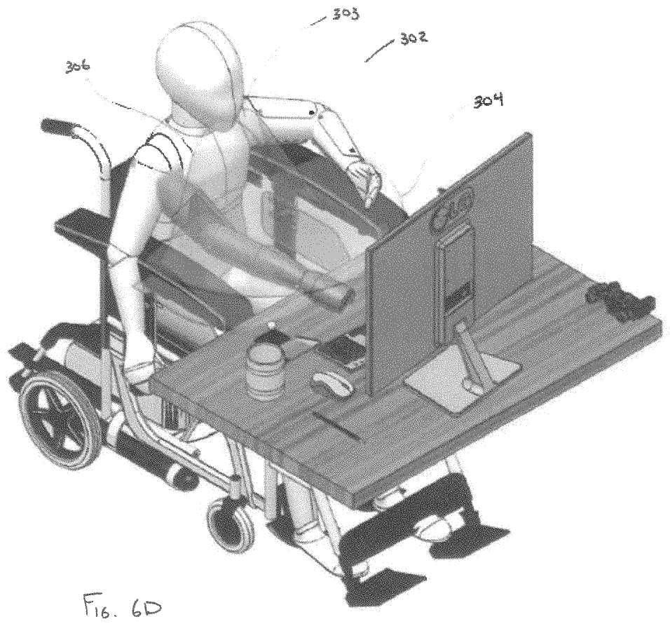

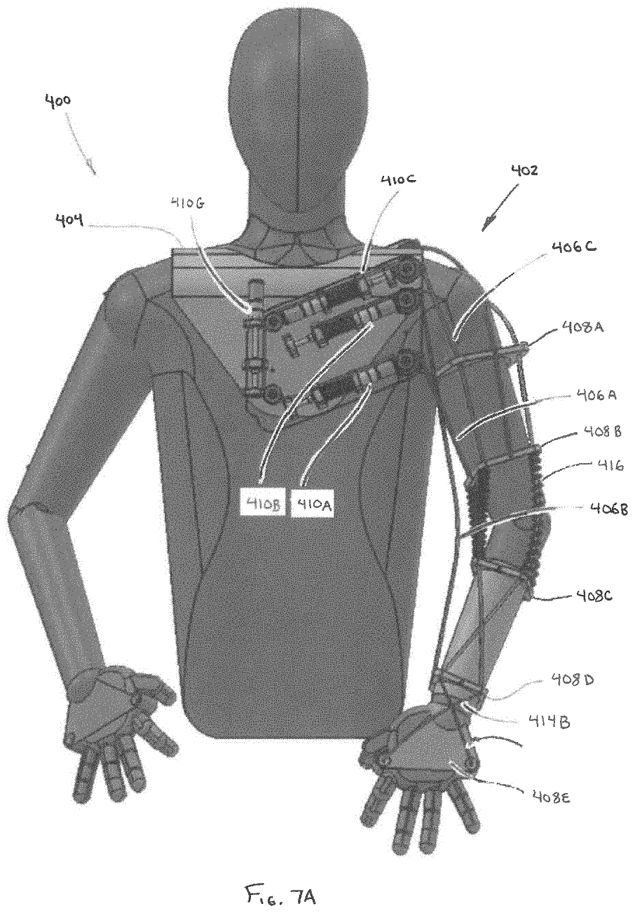

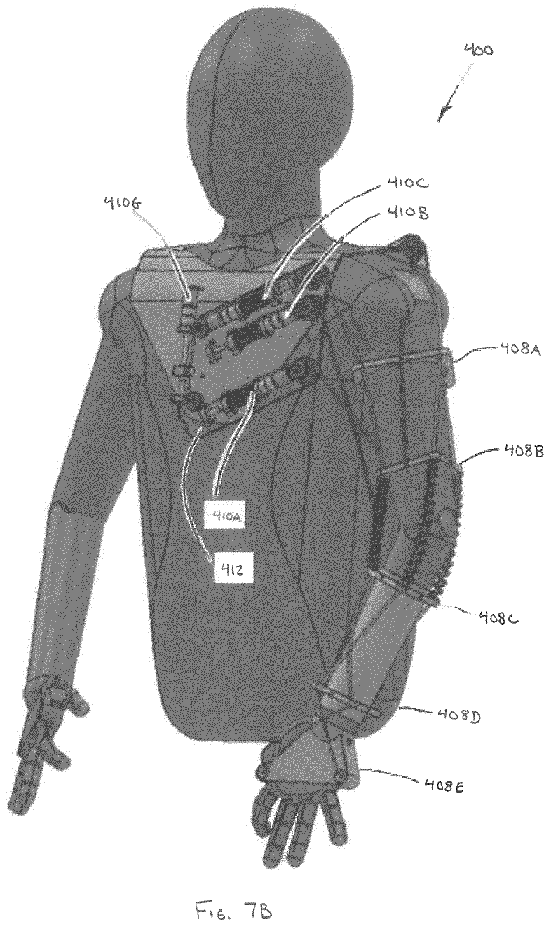

Referring to FIGS. 6A-D, desired ranges of motion for a user utilizing the upper torso augmentation system are depicted in accordance with an embodiment of the disclosure. In one embodiment, the upper torso augmentation systems can be configured to focus on “high-quality” upper torso augmentation by prioritizing limb movement within a predefined three-dimensional range of motion. In one embodiment, the three-dimensional range of motion can be shaped and sized to enable the user to maneuver their upper limbs, including their hands within an anterior three-dimensional envelope enabling many therapeutic and ADL functions. That is, although movements of the user's limb can extend outside of the predefined three-dimensional range of motion when using the upper torso augmentation system, augmentation of the limb movements can be prioritized within the predefined three-dimensional range of motion, thereby providing greater assistance, better control, and/or a higher degree of fidelity to limb movements within the three-dimensional range of motion.

The anterior three-dimensional envelope can have an average width of at least the width of the user's shoulders, wherein the width broadens towards a bottom of the envelope and narrows towards a top of the envelope. The envelope can have a height extending between the user's waist, lap, and/or tabletop and a portion of the user's face, for example the user's mouth. The envelope can have a depth extending between the user's hand, when the user's upper limb is extended in the anterior direction, and the user's torso, wherein the depth broadens towards the bottom of the envelope and narrows towards the top of the envelope.

In one embodiment, the predefined three-dimensional range of motion can be approximated by a concave cone 302. A vortex 303 of the concave cone 302 can be positioned proximal to the user's head and/or face, for example the user's nose. A base 304 of the concave cone 302 can be substantially parallel to the horizontal plane 305, and can be positioned proximal to, for example, the abdomen of the user. As depicted in FIG. 24B, the concave cone 302 can be intersected by a substantially vertical plane 306 positioned proximal to the user's torso.

In one embodiment, the base 304 of concave cone 302 can be vertically adjusted up and down, as desired. In one embodiment, movement of the upper torso augmentation system can be constrained horizontally, so as to enable the user to move their arms above the base 304, but not below the base 304. In some cases, constraining movement at or above a fixed plane, can enable the user to perform certain motions for a longer time, without the added fatigue of maintaining a horizontal position of their upper limbs against the effect of gravity. In one embodiment, the augmented movements within the prioritized three-dimensional envelope can include wrist extension, wrist flexion, lower arm pronation, lower arm supination, elbow flexion, upper arm elevation, upper arm rotation, and/or shoulder rotation.

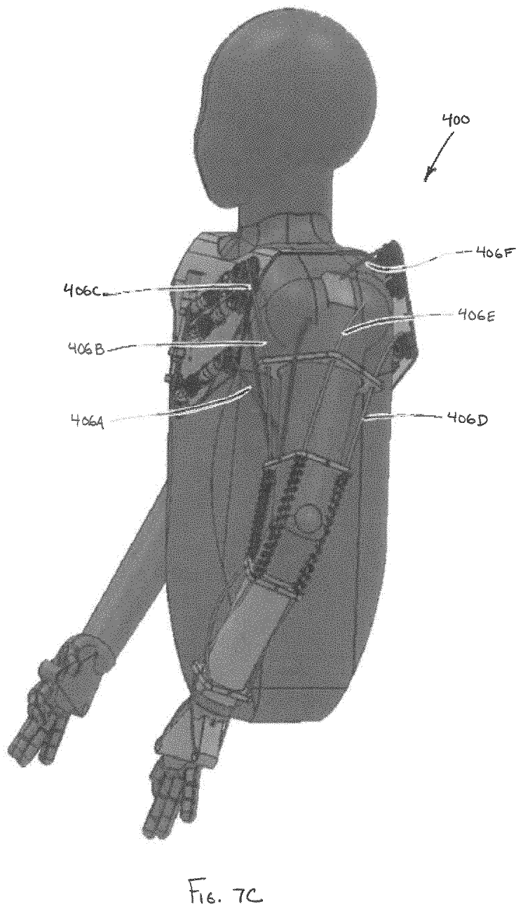

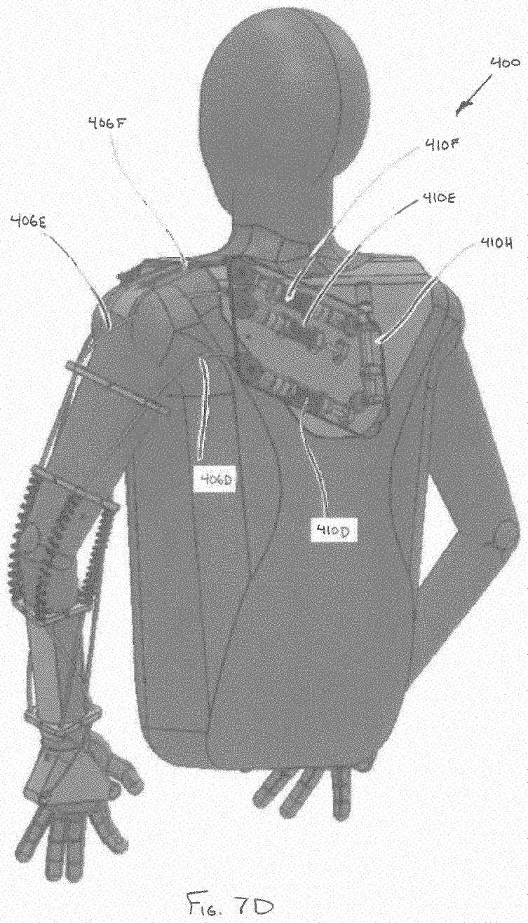

Referring to FIGS. 7A-E, another embodiment of the upper torso augmentation system 400 is depicted in accordance with the disclosure. The upper torso augmentation system 400 can utilize a plurality of cables to assist the user in daily tasks and/or therapeutic treatments to lower the force required to counteract gravity and maneuver the user's arm. In one embodiment, the upper torso augmentation system 400 includes a first, inner layer 402. In one embodiment, the first layer 402 can include a body chassis 404, a plurality of cables 406A-F, a plurality of cable restraints 408A-E, and a plurality of cable actuators 410A-H mounted to a support panel 412.

In one embodiment, each of the cables 406A-F can be used to define specific corresponding motions of the user's limb. The cables 406A-F can be controlled independently or simultaneously to affect more complex motions. The cables 406A-F can be passively powered by, for example springs and/or dampers, actively powered by a motor or actuator, and/or controlled by a hybrid passive and active spring-actuator mechanism. In one embodiment, use of passive elements within a hybrid power source can reduce the energy requirements required during active augmentation, thereby enabling ambulatory systems to run longer on a given battery source. For example, in one embodiment, a motor or actuator 410A-H can be utilized to indirectly affect motion of a user's limb by increasing or decreasing the force output of a spring configured to directly effectuate movement of an associated cable 406A-F.

In one embodiment, a first cable 406A can be operably coupled to actuator 410A. The first cable 406A can traverse from a point proximal to the user's chest, underneath the user's upper arm to a point proximal to an exterior, underside of the user's wrist. In one embodiment, a cable 414A can be operably coupled to the end of first cable 406A to terminate at a point proximal to an inside of the user's palm. In one embodiment, the cable 414A can be an extension of the first cable 406A. In one embodiment, the first cable 406A can traverse through a plurality of cable restraints 408A-E, thereby securing the first cable 406A to the user's arm.

A second cable 406B can be operably coupled to actuator 410B. The second cable 406B can traverse from a point proximal to the user's chest to a point proximal to an inside of the user's wrist. In one embodiment, second cable 406B can be routed outside of the plurality of cable restraints 408A-E, so that the second cable 406B can move away from the user's arm. In one embodiment, deviation from the user's arm enables the cable to affect lifting through a wider range of angles, thereby reducing the magnitude of the torque and/or compressive forces required for lifting.

A third cable 406C can be operably coupled to actuator 410C. The third cable 406C can traverse from a point proximal to the user's chest, along the front of the user's upper arm, to a point proximal to an exterior top of a user's wrist. In one embodiment, cable 414B can be operably coupled to the end of third cable 406C to terminate at a point proximal to the inside of the top of the user's hand. In one embodiment, cable 414B can be an extension of a third cable 406C. In one embodiment, the third cable 406C can traverse through plurality of cable restraints 408A-E, thereby securing the third cable 406C to the user's arm. In one embodiment, cable 414B can be operably coupled to cable 414A, and third cable 406C can be operably coupled to first cable 406A, thereby forming a continuous cable loop. In one embodiment, actuator 410G can assist in the movement of the continuous cable loop.

A fourth cable 406D can be operably coupled to actuator 410D. The fourth cable 406D can traverse from a point proximal to the user's back, along the rear of the user's upper arm, outside of the user's elbow, along the underside of the user's upper arm, to a point proximal to an outside of the user's wrist. In one embodiment, cable 414C can be operably coupled to the end of fourth cable 406D to terminate at a point proximal to an outside of the user's palm. In one embodiment, cable 414C can be an extension of fourth cable 406D. In one embodiment, the fourth cable 406D can traverse through plurality of cable restraints 408A-E, thereby securing the fourth cable 406D to the user's arm.

A fifth cable 406E can be operably coupled to actuator 410E. The fifth cable 406E can traverse from a point proximal to the user's back, over the user's shoulder, outside of the user's lower arm, over the user's elbow, to a point proximal to a top, inside of the user's wrist. A cable 414D can be operably coupled to the end of fifth cable 406E to terminate at a point proximal to an outside of the top of the user's hand. In one embodiment, cable 414D can be an extension of the fifth cable 406E. In one embodiment, the fifth cable 406E can traverse through a plurality of cable restraints 408A-E, thereby securing the first cable 406E to the user's arm. In one embodiment, cable 414C can be operably coupled to cable 414D, and fourth cable 406D can be operably coupled to fifth cable 406E, thereby forming a continuous cable loop. In one embodiment, actuator 410H can assist in the movement of the continuous cable loop.

A sixth cable 406F can be operably coupled to actuator 410F. The sixth cable 406F can traverse from a point proximal to the user's back, over the user's shoulder to terminate at a point above the user's elbow on the outside of the user's upper arm.

In one embodiment, in order to shield portions of the cables, one or more couplings 416 can be positioned between cable restraints. For example, in one embodiment, one or more semi-rigid, flexible, and/or resilient couplings 416 can be positioned between an upper arm cable restraint 408B and a lower arm cable restraint 408C. In one embodiment, the couplings 416 can serve to inhibit the cables from chafing the skin of the user and/or minimizing discomfort. In one embodiment, the couplings can serve to constrain the upper arm assembly relative to the lower arm assembly in a manner that enables the lower arm assembly to pivot relative to the upper arm assembly, but maintains an established separation distance, so as to inhibit the lower arm assembly from shifting closer to the upper arm assembly along a longitudinal axis of the coupling when tension is applied to the cables 406A-F. In some embodiments, one or more couplings of a similar construction can be utilized between the body chassis 404 and one or more of the upper arm cable restraints 408A.

Accordingly, in some embodiments, the cable restraints 408A-E (corresponding to the respective body chassis, upper arm assembly and lower arm assembly) can be semi-constrained relative to one another, so as to maintain a desired degree of separation and inhibit compression along a longitudinal axis of the coupling. In other respects, the body chassis, upper arm assembly and lower arm assembly can be free-floating relative to one another. In other words, the arm assemblies and body chassis can provide support to the user and apply forces to portions of the user's chest and arms, while being anatomically dependent upon the user's joints (e.g., shoulder and elbow) to pivot, rotate and/or shift relative to one another. That is, the upper torso augmentation system 400 can rely on the anatomy of the user to supply the rigid, pivotable framework necessary to effectuate movement of the user's arm through a broad range of motion. Accordingly, orthotic device 400 provides a low profile antigravity assist mechanism, without the added weight and bulk of linkages and hinge points enabling motion of the various portions of the upper torso augmentation system 400 external to the user's anatomy.

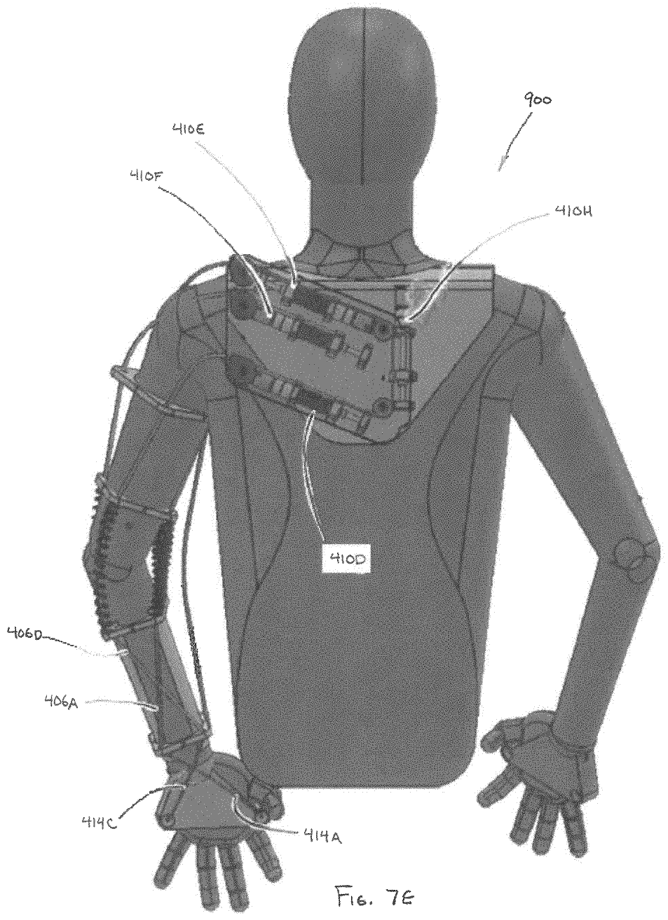

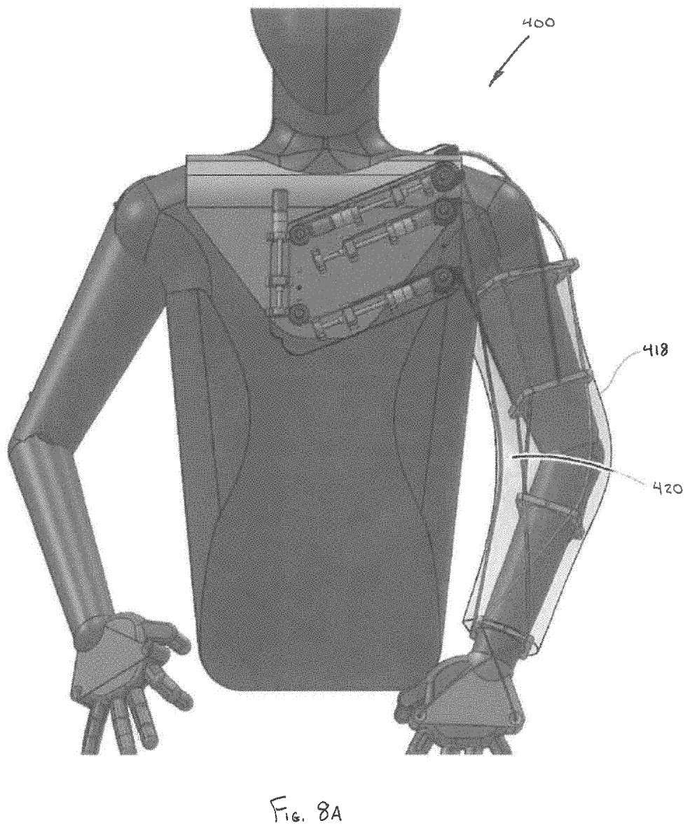

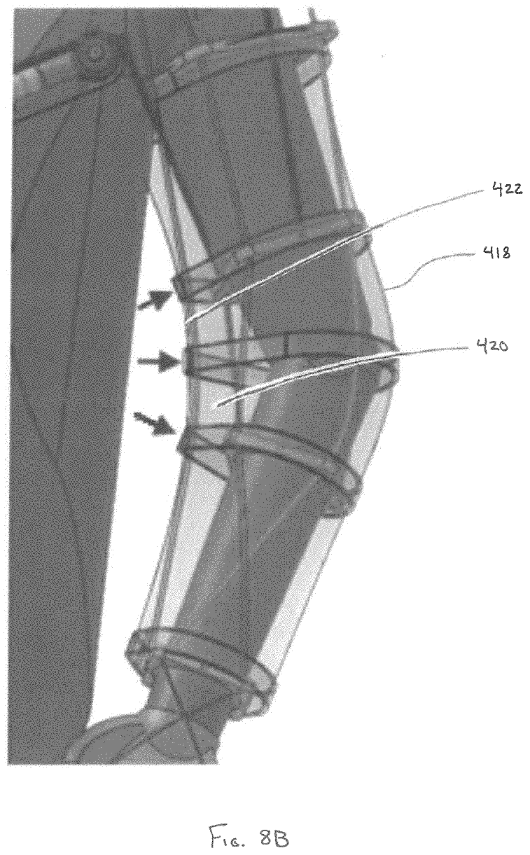

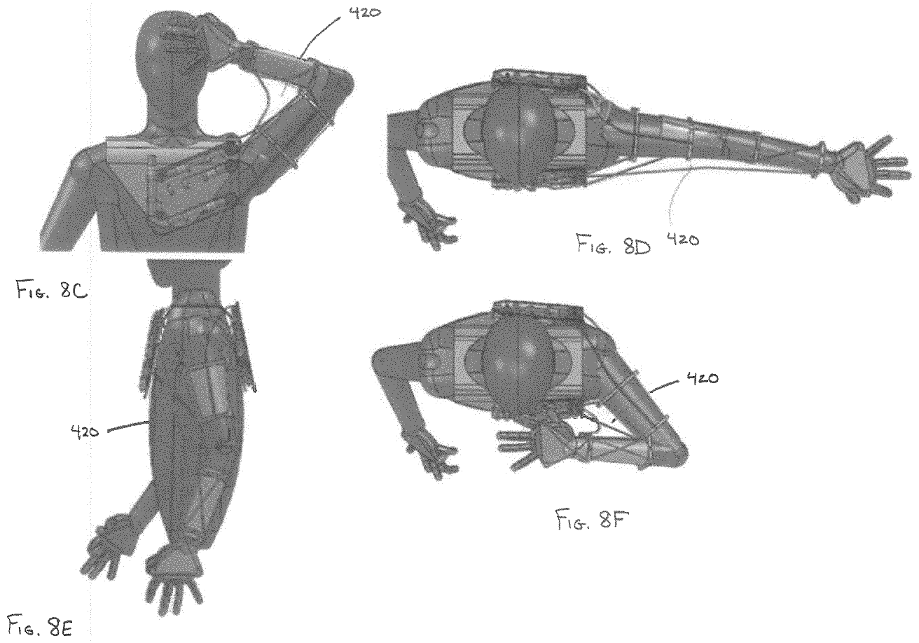

Referring to FIGS. 8A-F, the upper torso augmentation system 400 can further include a second, outer layer 418. The outer layer 418 can be configured as a jacket or sleeve that fits over the first, internal layer 402. In one embodiment, the second layer 418 can be constructed of an elastic, breathable fabric, configured to sheath portions of the internal layer 402.

In one embodiment, the second cable 406B (which can be routed outside of at least some of the plurality of cable restraints 408A-E) in combination with the outer layer 418 can define a cable wing 420, in particular, a leading edge 422 of the cable wing 420. The extent of the cable wing 420 can be defined by the elasticity of the outer layer 418, in combination with the force imparted on the second cable 406B. The varying shape of the cable wing 420 is depicted in FIGS. 8C-F. Cable wing 420 accordingly provides a balance between improving the mechanical advantage afforded by second cable 406B, while maintaining a low profile of the upper torso augmentation system 400 during use. In one embodiment, the elastic outer layer 418 can serve as a simulated fascia to the simulated muscles of the inner layer 402. For example, in one embodiment, the elastic outer layer 418 can provide passive assistance to at least the second cable 406B through its elasticity. The passive assistance can serve to both minimize the profile of the cable wing 420 as well as decrease the power requirements of the actuator 410B.

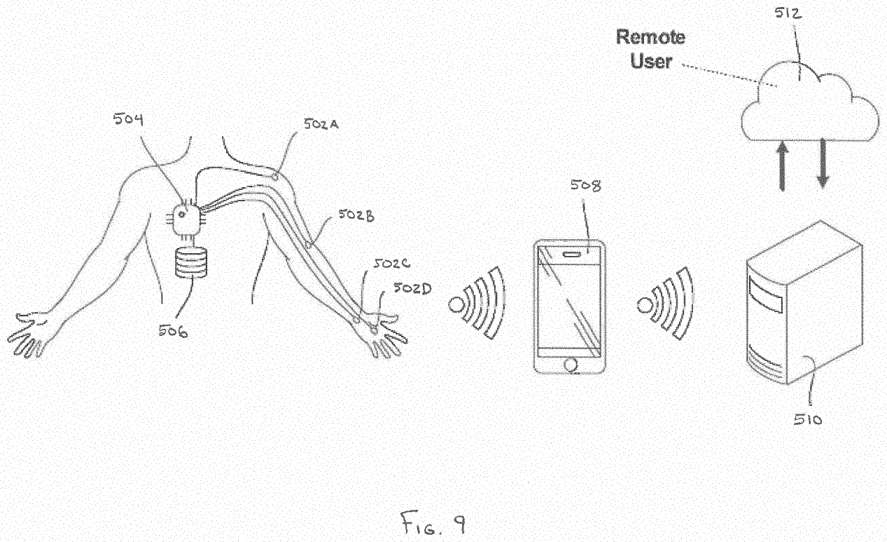

Referring to FIG. 9, embodiments of the upper torso augmentation system can include a plurality of sensing devices 502A-D configured to monitor one or more clinical parameters of interest during use. For example, the sensing devices can include inertial measurement unit (IMU) sensors, EMG sensors, or body motion sensors, such as accelerometers, angle sensors, and/or flex sensors. The plurality of sensing devices 502 can sense, for example, a position (e.g., pronation and/or supination of extremities), a continuous or sequence of tracked positions over a period of time, a range of motion of a user, dates and times of particular events, a total time of augmented activity, training, or rehabilitation, as well as other conditions of the user, such as a physiological strength profile, heart rate, electrical activity of the heart, and perspiration. In one embodiment, the upper torso augmentation system can further include one or more sensing devices configured to sense a user condition. For example, the sensing device can include heart rate sensors, peripheral capillary oxygen saturation (SpO2) sensors, EKG electrodes, temperature sensors, and/or humidity sensors. In one embodiment, the sensing devices are positioned within or proximal to portions of the body chassis, shoulder assembly, upper arm assembly, and/or lower arm assembly. In another embodiment, the sensing devices are positioned on or within a separate garment that is worn as an independent layer, underneath or overtop of these components.

In some embodiments, data sensed by the plurality of sensing devices 502 is communicated to a processor 504. Processor 504 can optionally store the sensed data to a memory 506. Sensed data collected by the processor 504 can be transmitted to one or more computing devices 508. In one embodiment, the computing device 508 can be a mobile computing device and/or a cellular telephone. The processor 504 can transmit the sensed data to the computing device 508 through either a wired connection or wirelessly.

The sensed data can be summarized and displayed on the computing device 508, thereby providing feedback to the user regarding their performance and/or use of the augmentation systems. For example, in one embodiment, the information can be utilized in a closed-loop control system configured to optimize a torque output produced by the upper torso augmentation system 100, or graded as part of a CIMT process. In one embodiment, predefined activity and/or motion goals can be set, such that information from the plurality of sensing devices can be used to indicate when the predefined goal has been achieved. In one embodiment, the processor 504 can be in continuous communication with the computing device 508, thereby providing a streaming source of feedback to the user. For example, in one embodiment, the computing device 508 can provide feedback regarding one or more physical therapy goals set by a clinician, such as a rehabilitation specialist. In other embodiments, the computing device 508 can remind the user that it is time to perform certain exercises of their ambulatory rehabilitation regimen.

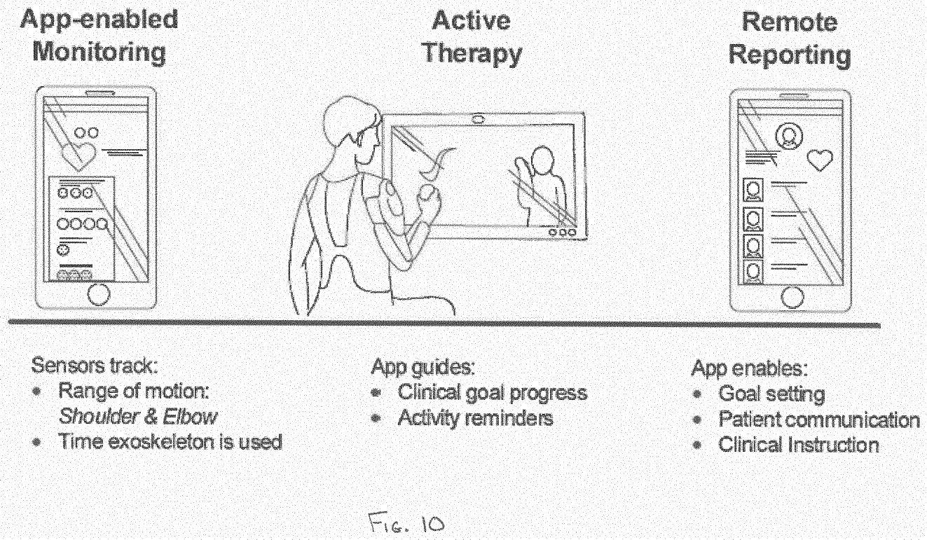

Information from the computing device 508 relating to the sensed data can be transmitted to one or more servers 510. In one embodiment, the computing device 508 can transmit the information to the server 510 through either a wired connection or wirelessly. The server 510 can be in communication with a data cloud 512 in which the information derived from the sensing devices 502 can be collected, analyzed and shared with others, including remote users. Accordingly, clinicians can check up on their patients remotely to determine if particular goals have been met, and if the patient is following their prescribed therapy regimen. As depicted in FIG. 10, based on this information, a clinician can redefine goals for the patient, communicate information, such as reminders to a patient, and/or provide other instruction beneficial to the patient.

In one embodiment, a clinician can select one or more exercises and/or assessments from a battery of training aids for the patient to perform on a scheduled basis. In one embodiment, the training aids can be in the form of a video. Thereafter, the patient can be reminded by the computing device 508 that it is time to perform their exercises. The computing device 508 can then sense when the user is ready to perform the exercise, and, when appropriate, play the training aid of the prescribed exercise for the user. While the user is performing the exercise, the computing device 508, in addition to tracking data via sensing devices 502, can record video of the user performing the exercise. The sensed data from the sensing devices 502 along with the video of the user performing the exercise, can then be reviewed by the clinician.

In one embodiment, sensing devices 502 can be configured to sense when the user is shaking, for example, as a result of fatigue. In hybrid embodiments, active power elements can be in communication with processor 504, such that the powered elements can be dynamically adjusted to compensate for the increased fatigue. For example, in one embodiment, the forces on the biasing elements can be increased to further augment the user's native muscles. In one embodiment, the powered elements, based on inputs from processor 504, serve to counteract the shaking of the user, for the purpose of enabling the user to steady their hand while performing certain tasks.

In one embodiment, the active power elements can receive direction from processor 504 to augment particular desired body motion amplification based on instructions from the user. For example, in one embodiment, one or more sensing devices 502 can be positioned in the body chassis and can be configured to detect movement of the user's head and/or neck. Movement of the head and/or neck by the user, which can be in combination with pressure applied to the upper or lower arm assemblies by the user's native muscles, can be interpreted as an intent to perform an action, such as moving the user's arm up or down, or to the left or right. For example, the user tilting their head forward can be interpreted as an indication that the user intends to raise their arms in order to see the object in their hands more closely, or to place food into their mouth. The user moving their head back to the prone position can be interpreted as an indication that the user intends to lower their arms. Similarly, the user either rotating or tilting their head to the right can be interpreted as an indication that the user intends to bring their right arm closer to their face. Again, the user moving their head back to the prone position can be interpreted as an indication that the user intends to return their arm to the earlier position. In other embodiments, intent activated augmentation variability can be affected by muscle force along the desired body motion track, control via a joystick or straw, eye tracking, or verbal control, for example via computing device 508. Accordingly, in some embodiments, limited input from the user (e.g., movement within a single degree of freedom), when interpreted as an intent to perform an action, can direct the processor 504 to augment desired body motion amplification through a desirable range of motion, which, for example, can include movement of the user's arm within nine degrees of freedom or more. In one embodiment, the active power elements can be operably coupled to a closed-loop control system configured to continuously receive updates from the one or more sensing devices 502 as to the position of the user's arm. For example, in one embodiment, the processor can be configured to receive one or more clinical parameters of interest from the one or more sensing devices 502 to determine at least one of a user's strength profile and/or a level of compliance with a prescribed exercise, and to command adjustment of the first adjustment mechanism and/or second adjustment mechanism based on the determined strength profile and/or level of compliance, so as to optimize a torque output produced by the upper torso augmentation system. In one embodiment, the closed-loop control systems can be particularly effective in treating conditions involving spasticity, or in other cases where unintentional (and often rapid) muscle activity causes the user's arm to deviate from a desired motion.

In one embodiment, a user can utilize the computing device 508 to track and record a particular motion. For example, the motion can be to turn the page on a book. Thereafter, based on the user's command and/or the interpreted intent of the user, the active power elements can receive direction from processor 504 to provide augmentation to guide the user's arm along the same track, thereby enabling the user to repeat a particular motion numerous times without the normal amount of fatigue that would accompany such repetitive motion.

In one embodiment, portions of the cuffs and/or body chassis can include power elements configured to apply pressure to the skin of the user. In one embodiment, based on the user's heart rate and/or EKG information, the active power elements can be employed to promote circulation in certain parts of the user's body. Accordingly, in some embodiments, portions of the upper torso augmentation systems can perform a peristaltic massaging function. Other embodiments of the body chassis can apply pressure to the skin of the user to aid in stabilizing the upper torso augmentation system when lifting heavy objects and/or when the user's arm is extended away from the user's torso.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not and/or 188 directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A motion augmentation system configured to be worn around a first body structure of a user and to utilize a plurality of cables to augment a native strength of the user to aid in the movement of an appendage of the user through a desired range of motion by applying a force between the first body structure and the appendage, the motion augmentation system comprising:
a body chassis configured to be worn around the first body structure;
at least one sleeve assembly configured to be worn around the appendage, the at least one sleeve assembly including a plurality of embedded lumens traversing through at least a partial length of the at least one sleeve assembly; and
a plurality of cables operably coupling the body chassis to the at least one sleeve assembly, each of the plurality of cables traversing through a corresponding one of the plurality of embedded lumens of the sleeve assembly and controlled by one or more corresponding cable actuators operably coupled to the body chassis, the corresponding cable actuators configured to selectively apply a force via the plurality of cables between the body chassis and the at least one sleeve assembly, such that the body chassis and the natural anatomy of the user are at least partially used as a structure against which the sleeve assembly pivots in response to the applied force.

2. The motion augmentation system of claim 1, wherein the body chassis and the at least one sleeve assembly are substantially free-floating relative to one another.

3. The motion augmentation system of claim 1, wherein the at least one sleeve assembly includes an upper appendage sleeve assembly and a lower appendage sleeve assembly.

4. The motion augmentation system of claim 3, wherein the upper appendage sleeve assembly and lower appendage sleeve assembly are operably coupled to one another via a resilient coupling.

5. The motion augmentation system of claim 4, wherein the resilient coupling substantially inhibits the lower appendage sleeve assembly from translating closer to the upper appendage sleeve assembly along a longitudinal axis of the resilient coupling when the force is applied between the body chassis and the at least one sleeve assembly.

6. The motion augmentation system of claim 1, further comprising a processor configured direct the one or more cable actuators to increase augmentation of the native strength of the user in maneuvering the appendage in a predefined direction based on cues from the user.

7. The motion augmentation system of claim 1, further comprising a processor configured to record a path of motion of the appendage and direct the one or more cable actuators in maneuvering the appendage along the recorded path of motion.

8. The motion augmentation system of claim 1, further comprising one or more sensing devices configured to monitor one or more clinical parameters of interest during use.

9. The motion augmentation system of claim 8, further comprising a processor configured to utilize the one or more clinical parameters of interest to determine an increased fatigue of the user and to dynamically adjust one or more cable actuators to compensate for the increased fatigue.

10. The motion augmentation system of claim 1, further comprising one or more passive elements configured to selectively apply at least a portion of the force between the body chassis and the at least one sleeve assembly.

11. The motion augmentation system of claim 10, wherein the cable actuators are configured to apply the force between the body chassis and the at least one sleeve assembly by changing a force output of the one or more passive elements.

12. A low-profile, conformable multilayer motion augmentation system configured to be worn around a first body structure of a user and to augment a native strength of the user by aiding movement of an upper appendage and a lower appendage of the user, the multilayer motion augmentation system comprising:
a first layer, including—
a body chassis configured to be worn around the first body structure;
a plurality of cables at least partially constrained relative to the upper appendage and the lower appendage by a plurality of cable restraints, wherein at least one of the plurality of cables is unconstrained relative to a joint between the upper appendage and the lower appendage, and
a plurality of cable actuators, each of the plurality of cable actuators operably coupled to the body chassis and configured to impart a force on a respective one of the plurality of cables; and
a second layer, including—
an elastic sleeve portion configured to sheath at least a portion of the plurality of cables and cable restraints of the first layer, wherein the at least one of the plurality of cables that is unconstrained relative to the joint between the upper appendage and the lower appendage, in combination with the elastic sleeve portion, define a leading edge of a cable wing.

13. The low-profile, conformable multilayer motion augmentation system of claim 12, wherein the first layer further comprises an upper appendage sleeve assembly and a lower appendage sleeve assembly.

14. The motion augmentation system of claim 13, wherein the upper appendage sleeve assembly and lower appendage sleeve assembly are operably coupled to one another via a resilient coupling.

15. The motion augmentation system of claim 14, wherein the resilient coupling inhibits the lower appendage sleeve assembly from translating closer to the upper appendage sleeve assembly along a longitudinal axis of the resilient coupling when the force is applied to the plurality of cables.
